(19) United States
(12) Patent Application Publication
(10) Pub. No.: US 2012/0291819 A1
(43) Pub. Date: Nov. 22, 2012

(54) CLEANING APPARATUS AND CLEANING METHOD FOR COATING GUN

(75) Inventors: Takashi Wakimoto, Tochigi (JP); Masaaki Shoji, Tochigi (JP); Yutaka Hariya, Tochigi (JP); Koji Ikeda, Tochigi (JP); Yoshiyuki Kumano, Tochigi (JP); Toshiyuki Kokubo, Tochigi (JP); Shinji Noda, Tochigi (JP)

(73) Assignee: Honda Motor Co., Ltd., Tokyo (JP)

(21) Appl. No.: 13/522,931

(22) PCT Filed: Feb. 10, 2011
(86) PCT No.: PCT/JP2011/052839

§ 371 Date: Jul. 18, 2012

(30) Foreign Application Priority Data
Feb. 12, 2010 (JP) 2010-028999
Apr. 26, 2010 (JP) 2010101295
Aug. 24, 2010 (JP) 2010-187506

(51) Int. Cl. B08B 9/02; B23P 11/00; B08B 9/023; B08B 3/02; B08B 9/032

(52) U.S. Cl. 134/36; 134/166 R; 134/172; 134/22.11; 134/198; 134/99.1; 29/428

(57) ABSTRACT

A rotary atomizing head (125, 226) is rotatably provided on a leading end of a coating gun (115, 215). The rotary atomizing head (125, 226) is provided with a central paint discharge opening (141, 241) provided in a vicinity of a rotation axis (137, 237) of the rotary atomizing head (125, 226) and an outer paint discharge opening (142, 242) having a central axis (148, 248) inclined relative to the rotation axis (137, 237). A cleaning nozzle (124, 225) has an axis (127, 228) which aligns with the central axis (148, 248) of the outer paint discharge opening (142, 242) when the coating gun (115, 215) is cleaned.

### TECHNICAL FIELD

The present invention relates to an improvement in a cleaning technique for a coating gun incorporating a rotary atomizing head as an objected to be cleaned.

### BACKGROUND ART

For example, there is a case where a single coating gun discharges multiple types of paints depending on products to be painted. In order to remove the paint remaining in the coating gun when changing the type of the paint, a technology has been proposed for cleaning a rotary atomizing head mounted on a leading end of the coating gun (for example, see Patent Document 1 (FIG. 4), Patent Document 2 (FIG. 4) and Patent Document 3 (FIG. 2)).

According to the system disclosed in Patent Document 1 a rotary atomizing head 1100 is rotatably mounted on a leading end of a coating gun, as illustrated in FIG. 29. The rotary atomizing head 1100 is provided with a central paint discharge opening 1101 for discharging the paint in a vicinity of a rotation axis thereof and an outer paint discharge opening 1102 for obliquely discharging the paint in a conical shape relative to the rotation axis.

When the rotary atomizing head 1100 is cleaned, a cleaning nozzle 1103 is placed to oppose the central paint discharge opening 1101 such that a central axis of the cleaning nozzle 1103 aligns with a rotational axis of the rotary atomizing head 1100. The cleaning liquid is discharged from the cleaning nozzle 1103 toward the central paint discharge opening 1101. A portion of the cleaning liquid is blown into a paint reservoir 1104 positioned on a rear side of the rotary atomizing head 1100 through the central paint discharge opening 1101 to wash out the paint 1105. The cleaning liquid cleans an interior of the paint reservoir 1104 and then is discharged through the outer paint discharge opening 1102. Further, remaining portions of the cleaning liquid is flowing along a paint thinning surface 1106 of the rotary atomizing head 1100 to clean the paint thinning surface 1106.

However, since the central paint discharge opening 1101 is small in number and the amount of the cleaning liquid blown through the central paint discharge opening is small, man-hour is required for cleaning the interior of the paint reservoir 1104. Further, there is a risk that the cleaning liquid flows backward to a paint feed tube 1107 depending on the direction of the central paint discharge opening 1101. Accordingly, a cleaning technique for a coating gun has been demanded, which is capable of improving the cleaning efficiency of the rotary atomizing head with no risk that the cleaning liquid flows backward to the paint feeding tube.

Further, according to the system disclosed in Patent Document 2, a cleaning apparatus 2101 for a coating gun 2100 includes a lid 2102 provided on an upper portion of an entire cover, as illustrated in FIG. 30. A rubber insertion guide member 2103 is provided near the center of the lid 2102. A head 2104 for spraying the paint is provided on a leading end of the coating gun 2100 mounted on a painting robot. The head 2104 of the coating gun 2100 is inserted into the insertion guide member 2103.

Meanwhile, at the end of paragraph [0028] of Patent Document 2, there is a description of “since the insertion guide member 24 is made of rubber, the insertion guide member can be easily elastically deformed even if the insertion position of the coating gun 7 is slightly shifted.”

That is, the system of Patent Document 2 assumes that the insertion position of the coating gun 2100 is slightly shifted. However, if the insertion position of the coating gun 2100 is shifted, the paint discharge opening of the head 2104 and the central axis of the cleaning nozzle 2105 are shifted from each other. For this reason, the cleaning liquid discharged from the cleaning nozzle 2105 cannot effectively enter the paint discharge opening. Consequently, efficiency for cleaning the paint remaining on the paint reservoir as a rear side of the head 2104 is poor.

Accordingly, it is necessary to accurately align the central axis of the cleaning nozzle 2105 with the head 2014 as an object to be cleaned. However, it is difficult and takes time to perform the alignment by teaching the painting robot. That is, a technique has been demanded, which is capable of easily aligning the central axis of the cleaning nozzle with an object to be cleaned.

Further, according to the system disclosed in Patent Document 3, a cleaning apparatus 3100 for a rotary atomizing head includes a conical rotary atomizing head 3102 rotatably mounted on a leading end of a coating machine body 3101, as illustrated in FIG. 31. The paint supplied to the rotary atomizing head 3102 is scattered and atomized from a front surface of the rotary atomizing head 3102 toward an outer periphery thereof by a rotational centrifugal force and thus adhered to an object to be painted. At this time, there is a case that a portion of the paint is adhered to a rear surface 3103 of the rotary atomizing head 3102.

When the rear surface 3103 of the rotary atomizing head 3102 is cleaned, a cleaning nozzle 3104 for discharging the cleaning liquid is placed obliquely downward at a position spaced from the rear surface 3103 of the rotary atomizing head 3102. The cleaning liquid discharged from the cleaning nozzle 3104 strikes against the rear surface 3103 of the rotary atomizing head 3102 being rotated, thereby cleaning the rear surface 3103 of the rotary atomizing head 3102.

However, since the cleaning nozzle 3104 is spaced apart from the rear surface 3103, a portion of the cleaning liquid strongly discharged on the rear surface 3103 of the rotary atomizing head 3102 is scattered and thus coating machine body 3101, etc. can be contaminated. As the contamination is accumulated, there is a risk that contaminant falls on an object to be painted during painting operation. Accordingly, a cleaning technique has been demanded, in which there is no risk that the cleaning liquid is scattered to the coating machine body upon cleaning of the outer surface of the rotary atomizing head.

### PRIOR ART DOCUMENT

### Patent Document

Patent Document 1: JP-A-11-216403

Patent Document 2: JP-A-09-262518

Patent Document 3: JP-A-2006-334575

### SUMMARY OF INVENTION

One or more embodiments of the present invention provide a cleaning technique for a coating gun, which is capable of improving a cleaning efficiency of a rotary atomizing head with no risk that a cleaning liquid flows backward to a paint feeding tube and easily aligning a central axis of a cleaning nozzle with an object to be cleaned and in which there is no risk that the cleaning liquid is scattered to the coating gun upon cleaning of an outer surface of the rotary atomizing head.

In accordance with one or more embodiments of the invention, a cleaning apparatus 120, 220 for a coating gun 115, 215, in which the coating gun 115, 215 includes a rotary atomizing head 125, 226 which is rotatably provided on a leading end of the coating gun 115, 215, and wherein the rotary atomizing head 125, 226 includes a central paint discharge opening 141, 241 provided in a vicinity of a rotation axis 137, 237 of the rotary atomizing head 125, 226 and an outer paint discharge opening 142, 242 having a central axis 148, 248 inclined relative to the rotation axis 137, 237, may include: a cylindrical container 121, 221 to which the coating gun 115, 215 can be inserted downwards from a top of the cylindrical container 121, 221; and a cleaning nozzle 124, 225 attached to the cylindrical container 121, 221, having an axis 127, 228 which aligns with the central axis 148, 248 of the outer paint discharge opening 142, 242 in a state where the coating gun 115, 215 is inserted into the cylindrical container 121, 221, and configured to inject cleaning liquid to the outer paint discharge opening 142, 242.

Moreover, in accordance with one or more embodiments of the invention, a cleaning apparatus may include: a support block 253; a rotary block 256 rotatably supported on the support block 253; and a cleaning nozzle 225 inserted into a nozzle insertion hole 255 provided on the rotary block 256. A rotational center line 254 of a rotation of the rotary block 256 relative to the support block 253 and a central axis 228 of the cleaning nozzle 225 may be parallel to each other and offset from each other.

Moreover, in accordance with one or more embodiments of the invention, a cleaning method for a coating gun 115, 215, in which the coating gun 115, 215 includes a rotary atomizing head 125, 226 which is rotatably provided on a leading end of the coating gun 115, 215, and wherein the rotary atomizing head 125, 226 includes a central paint discharge opening 141, 241 provided in a vicinity of a rotation axis 137, 237 of the rotary atomizing head 125, 226 and an outer paint discharge opening 142, 242 having a central axis 148, 248 inclined relative to the rotation axis 137, 237, may include: a process of placing a cleaning nozzle 124, 225 to oppose the outer paint discharge opening 142, 242 such that an axis 127, 228 of the cleaning nozzle 124, 225 adapted to inject cleaning liquid align with the central axis 148, 248 of the outer paint discharge opening 142, 242; and a process of injecting the cleaning liquid from the cleaning nozzle 124, 225 to the outer paint discharge opening 142, 242 and discharging the cleaning liquid from the central paint discharge opening 141, 241 or the outer paint discharge opening 142, 242 to clean the rotary atomizing head 125, 226.

Moreover, in accordance with one or more embodiments of the invention, a nozzle position adjusting method in a cleaning apparatus, in which an object 226 to be cleaned is provided to be movable toward the cleaning apparatus 220, the cleaning apparatus 220 includes a cleaning nozzle 225 adapted to discharge cleaning liquid to the object 226, and the cleaning apparatus 220 includes a nozzle position adjusting mechanism 224 adapted to adjust a positional shift when a position of the cleaning liquid discharged from the cleaning nozzle 225 is shifted from a position of the objected 226, may include: a process of preparing a support block 253 that is provided on the cleaning apparatus 220 and has a support hole 252 extending in a direction parallel to a central axis 228 of the cleaning nozzle 225, a rotary block 256 that is rotatably accommodated in the support hole 252 and has a nozzle insertion hole 255 which is provided at a position offset from a rotational center line 254 of the support hole and through which the cleaning nozzle passes, and a coupling mechanism 257 adapted to fix the rotary block 256 to the support block 253 at an arbitrary rotational position of the rotary block 256; a process of moving the object 226 and stopping the object 226 when a distance between the object and the cleaning nozzle 225 is the smallest; a process of rotating the rotary block 256 to adjust an oriented direction of the cleaning nozzle 225; and a process of coupling the rotary block 256 to the support block 253 by the coupling mechanism 257.

Moreover, in accordance with one or more embodiments of the invention, a cleaning apparatus 20 for a rotary atomizing head, in which a rear surface 25 of the rotary atomizing head 19 of a coating gun 15 adapted to inject paint forward while atomizing the paint by rotating the rotary atomizing head 19 is cleaned, may include: a liquid supply pipe 26 extending to the rear surface 25 of the rotary atomizing head 19 and to which cleaning liquid is supplied; and a discharge opening 44 opened to the liquid supply pipe 26 and adapted to discharge the cleaning liquid to the rear surface 25 of the rotary atomizing head 19.

Furthermore, in accordance with one or more embodiments of the invention, a cleaning method for a rotary atomizing head, in which a rear surface 25 of the rotary atomizing head 19 of a coating gun 15 adapted to inject paint forward while atomizing the paint by rotating the rotary atomizing head 19 is cleaned, may include: a process of extending a liquid supply pipe 26 that feeds cleaning liquid to a rear surface 25 of the rotary atomizing head 19; and a process of discharging solvent to the rear surface 25 from a discharge opening 44 which is opened to the liquid supply pipe 26.

The other features and effects are apparent from the description of embodiments and appended claims.

### BRIEF DESCRIPTION OF DRAWINGS

FIG. 1 is a view illustrating an example of use of a cleaning apparatus according to a first exemplary embodiment.

FIG. 2 is a cross-sectional view illustrating the cleaning apparatus according to the first exemplary embodiment.

FIG. 3 is a cross-sectional view taken along line 3-3 of FIG. 1.

FIG. 4 is a view illustrating essential parts in the first exemplary embodiment.

FIG. 5 (a) is a view explaining an operation of a cleaning apparatus according to a comparative example and FIG. 5 (b) is a view explaining an operation of the cleaning apparatus according to the first exemplary embodiment.

FIG. 6 is a view illustrating a modification of the cleaning apparatus according to the first exemplary embodiment.

FIG. 7 is a view illustrating an example of use of a cleaning apparatus according to a second exemplary embodiment.

FIG. 8 is a cross-sectional view illustrating the cleaning apparatus according to the second exemplary embodiment.

FIG. 9 is a cross-sectional view taken along line 9-9 of FIG. 7.

FIG. 10 is a view explaining a positional relationship between a portion to be cleaned and a cleaning nozzle.

FIG. 11 is a front view illustrating a nozzle position adjusting mechanism.

FIG. 12 is a perspective view illustrating the nozzle position adjusting mechanism.

FIG. 13 is a view explaining an operation of the nozzle position adjusting mechanism.

FIG. 14 is view illustrating a modification of FIG. 12.

FIG. 15 is a view illustrating an example of use of a cleaning apparatus according to a third exemplary embodiment of the present invention.

FIG. 16 is a view as seen from arrow 16 of FIG. 15.

FIG. 17 is a view illustrating essential parts of the cleaning apparatus according to the third exemplary embodiment.

FIG. 18 is an expanded view of the essential parts of the cleaning apparatus.

FIG. 19 is a view as seen from arrow 19-19 of FIG. 17.

FIG. 20 is a view illustrating a discharge opening. FIG. 20 (a) is a cross-sectional view taken along line 20-20 of FIG. 19 and FIG. 20 (b) is a view as seen from arrow b of FIG. 20 (a).

FIG. 21 is a view illustrating a modification of the discharge opening.

FIG. 21 (a) is a view corresponding to a cross-sectional view taken along line 20-20 of FIG. 19 and FIG. 21 (b) is a view as seen from arrow b of FIG. 21 (a).

FIG. 22 is a view illustrating a modification of the discharge opening. FIG. 22 (a) is a view corresponding to a cross-sectional view taken along line 20-20 of FIG. 19 and FIG. 22 (b) is a view as seen from arrow b of FIG. 22 (a).

FIG. 23 is a view illustrating a modification of the discharge opening. FIG. 23 (a) is a view corresponding to a cross-sectional view taken along line 20-20 of FIG. 19 and FIG. 23 (b) is a view as seen from arrow b of FIG. 23 (a).

FIG. 24 (a) and (b) are views explaining an operation of a coating device.

FIG. 25 is a view explaining an operation of a cleaning apparatus for a rotary atomizing head.

FIG. 26 is a view illustrating a cleaning operation using water.

FIG. 27 is a view illustrating a fourth exemplary embodiment.

FIG. 28 is a view illustrating a fifth exemplary embodiment.

FIG. 29 is a view explaining the basic principle of a related art.

FIG. 30 is a view explaining the basic principle of a related art.

FIG. 31 is a view explaining the basic principle of a related art.

### DESCRIPTION OF EMBODIMENTS

Exemplary embodiments of the present invention will be respectively described by referring to the accompanying drawings. It should be noted that the drawings are viewed along the directions of the symbols.

### EMBODIMENTS

### First Exemplary Embodiment

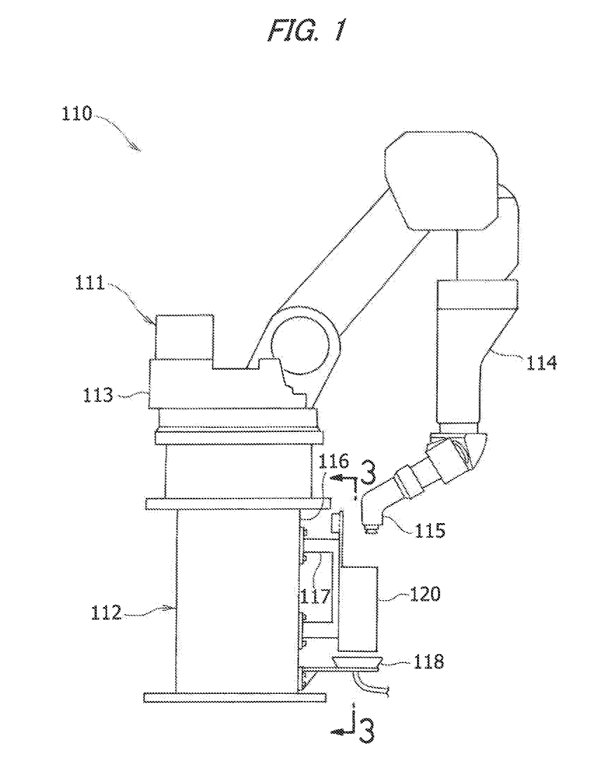

As illustrated in FIG. 1, in a first exemplary embodiment, coating equipment 110 includes a coating machine 111 and a cleaning apparatus 120 for a coating gun.

The coating machine 111 includes a base part 112, an industrial robot 113 provided on an upper portion of the base part 112 and a coating gun 115 provided on a leading end of an arm portion 114 of the industrial robot 113.

The cleaning apparatus 120 for the coating gun is attached to a sidewall 116 of the base part 112 via a stay 117. Further, a cleaning liquid pan 118 receiving cleaning liquid after cleaning is arranged on a lower portion of the cleaning apparatus 120 for the coating gun.

Next, the cleaning apparatus 120 for the coating gun will be described on the basic of the cross-sectional view.

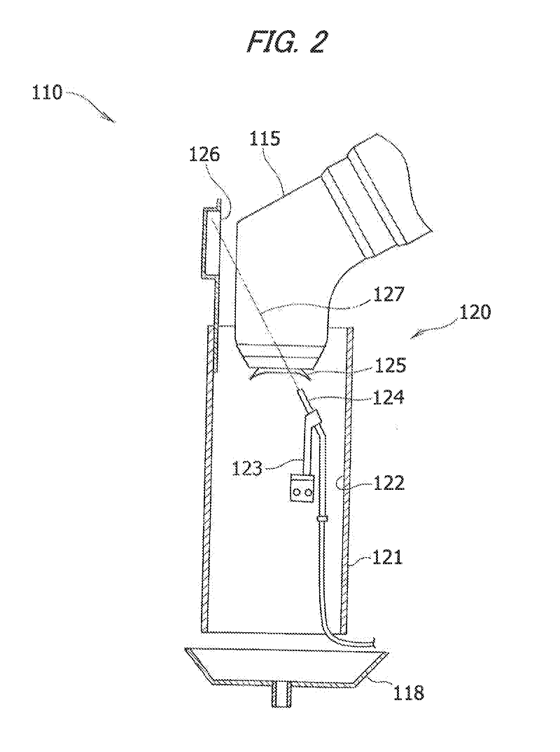

As illustrated in FIG. 2, the cleaning apparatus 120 for the coating gun includes a cylindrical container 121 through which a coating gun 115 can be inserted downwards from the top, a cleaning nozzle 124 attached to an inner peripheral surface 122 of the cylindrical container 121 via a nozzle stay 123 (that is, stay for nozzle) to inject the cleaning liquid and the cleaning liquid pan 118 provided on a lower portion of the cylindrical container 121 to receive the cleaning liquid after cleaning. As the cleaning liquid is injected from the cleaning nozzle 124, a rotary atomizing head 125 rotatably provided on a leading end of the coating gun 115 can be cleaned.

Further, a scattering prevention member 126 is attached to the cylindrical container 121 to be placed on an axis 127 of the cleaning nozzle 124. The scattering prevention member 126 allows the cleaning liquid to fall into the cylindrical container 121 when the cleaning liquid injected from the cleaning nozzle 124 does not strike the coating gun 115. Thereby, it is possible to prevent the cleaning liquid from being scattered to the outside.

Next, a cleaning nozzle for an external surface will be described.

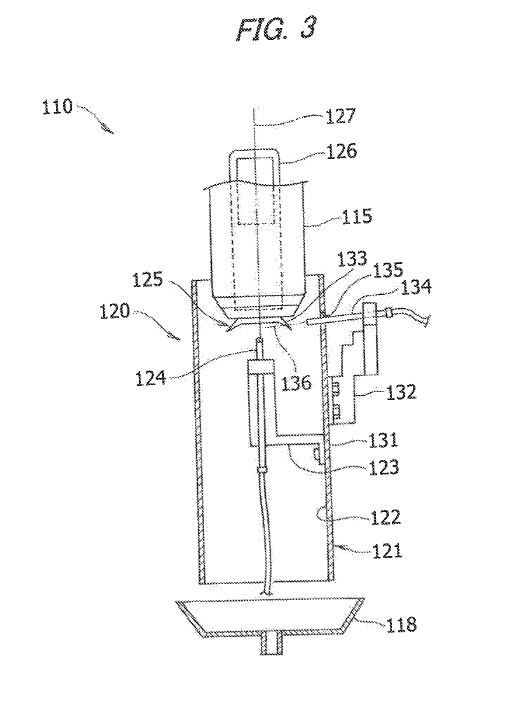

As illustrated in FIG. 3, the cleaning apparatus 120 for the coating gun includes an external surface cleaning nozzle 134 which is attached to an outer peripheral surface 131 of the cylindrical container 121 via an external surface nozzle stay 132. The external surface cleaning nozzle 134 is configured to inject the cleaning liquid on an external surface 133 of the rotary atomizing head 125. The external surface cleaning nozzle 134 extends through a through hole 135 of the cylindrical container 121 to the inside of the cylindrical container 121. The external surface cleaning nozzle 134 is positioned in such a way that the external surface 133 of the rotary atomizing head 125 is placed on an axis 136 of the external surface cleaning nozzle 134. Thereby, it is possible to clean the external surface 133 of the rotary atomizing head 125. The cleaning liquid after cleaning flows downwards along the inside of the cylindrical container 121 to be collected in the cleaning liquid pan 118.

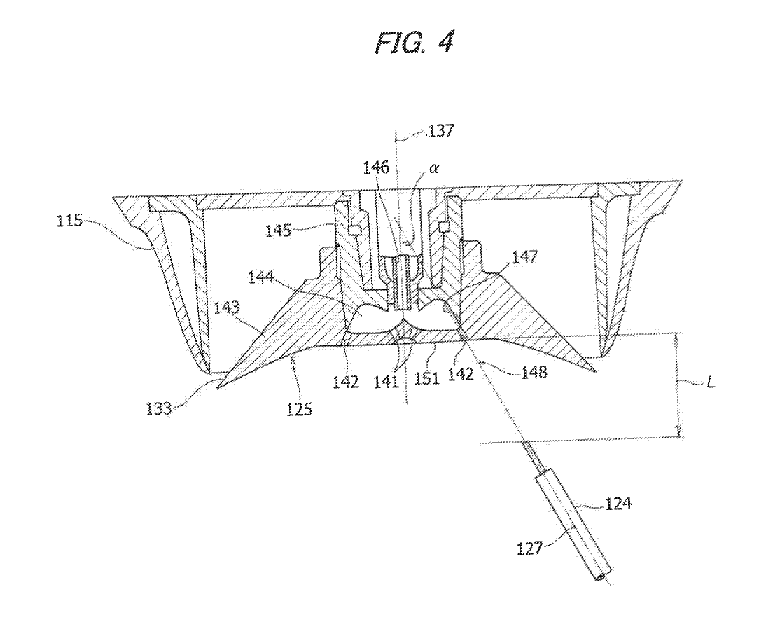

Next, the shape of the rotary atomizing head 125 will be described. As illustrated in FIG. 4, the rotary atomizing head 125 is rotatably provided on the leading end of the coating gun 115. The rotary atomizing head 125 is provided with central paint discharge openings 141 for discharging the paint in the vicinity of a rotation axis 137 of the rotary atomizing head 125 and outer paint discharge openings 142 for obliquely discharging the paint in a conical shape relative to the rotation axis 137.

The rotary atomizing head 125 includes an outer member 143, an inner member 145 and a paint feeding tube 146 for guiding the paint to the outer member 143. A paint reservoir 144 as a rear side of the rotary atomizing head 125 is formed between the outer member and the inner member.

The paint reservoir 144 is formed in a bell shape and a sidewall 147 thereof is smoothly connected to the outer paint discharge openings 142. Thereby, it is possible to smoothly discharge the paint.

The axis 127 of the cleaning nozzle 124 is overlapped with the central axis 148 of the outer paint discharge openings 142. Man-hour is required for cleaning the sidewall 147 of the paint reservoir even when the cleaning liquid is supplied from the paint feeding tube. However, as the cleaning liquid is smoothly supplied from the cleaning nozzle 124 to the outer paint discharge openings 142, the sidewall 147 of the paint reservoir can be effectively cleaned.

The axis 127 of the cleaning nozzle is offset relative to the rotation axis 137 by an angle of α. Further, the distance from a bottom 151 of the rotary atomizing head 125 to a leading end of the cleaning nozzle 124 is defined as “L”.

Next, an operation of the cleaning apparatus 120 for the coating gun mentioned above will be described.

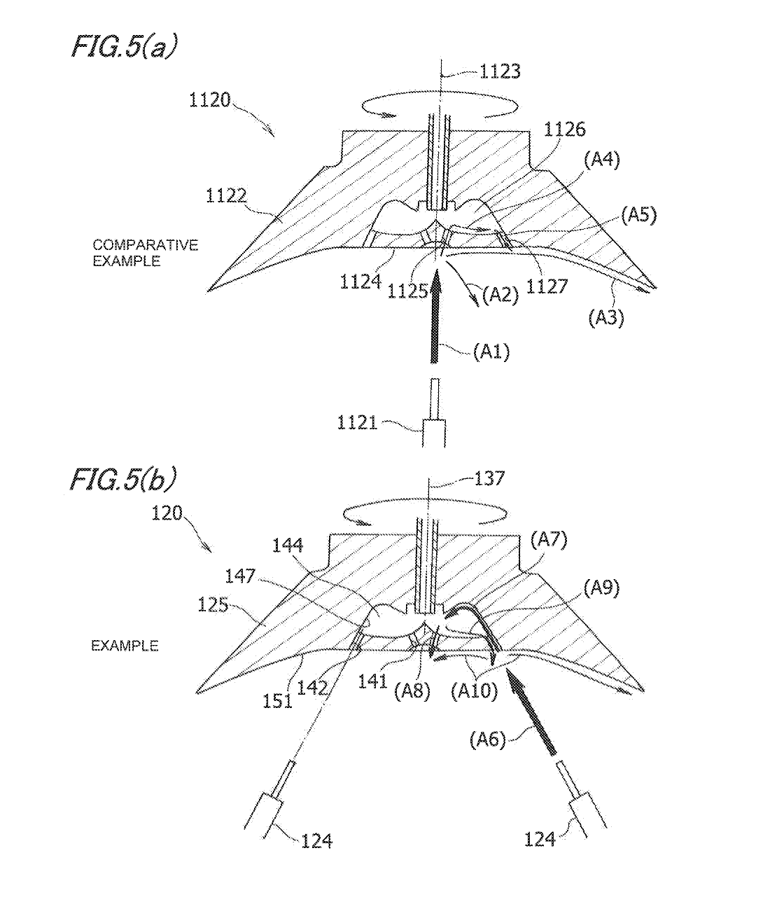

FIG. 5 (a) is a view explaining an operation of a cleaning apparatus 1120 for the coating gun according to a comparative example. In this cleaning apparatus, a cleaning nozzle 1121 is placed on a rotation axis 1123 of a rotary atomizing head 1122.

The cleaning nozzle 1121 is adapted to discharge the cleaning liquid, as indicated by arrow A1. A portion of the cleaning liquid is bounced at a bottom 1124 of the rotary atomizing head 1122, as indicated by arrow A2 and another portion thereof flows as indicated by arrow A3, to clean the bottom 1124.

Remaining portion of the cleaning liquid is blown from a central paint discharge opening 1125 and then flows as indicated by arrow A4. In this way, the cleaning liquid cleans a paint reservoir 1126 as a back side of the rotary atomizing head 1122 and then is discharged to the outside through an outer paint discharge opening 1127, as indicated by arrow A5.

Since the amount of the cleaning liquid blown into the paint reservoir 1126 is small in the cleaning apparatus 1120 of a comparative example, the cleaning man-hour is further required and thus a cleaning efficiency is not good.

FIG. 5 (b) is a view explaining an operation of the cleaning apparatus 120 for the coating gun according to the first exemplary embodiment. Here, the cleaning nozzle 124 is placed to oppose the outer paint discharge openings 142 in such a way that an axis (reference numeral 127 in FIG. 4) of the cleaning nozzle is overlapped with a central axis (reference numeral 148 in FIG. 4) of the outer paint discharge openings 142 (a cleaning nozzle placing process).

The cleaning liquid is blown from the cleaning nozzle 124 into the outer paint discharge openings 142 as indicated by arrow A6, cleans the paint reservoir 144 as a back side of the rotary atomizing head 125 as indicated by arrow A7 and then is discharged to the outside through the central paint discharge openings 141 as indicated by arrow A8 (a cleaning process). A portion of the cleaning liquid flowing into the paint reservoir is discharged through the outer paint discharge openings 142, as indicated by arrow A9. Further, a portion of the cleaning liquid injected from the cleaning nozzle 124 flows as indicated by arrow A10 to clean the bottom 151 of the rotary atomizing head 125.

Since the cleaning liquid is blown from the outer paint discharge openings 142, the cleaning liquid can smoothly flow along a sidewall 147 of the paint reservoir and thus a cleaning efficiency is good.

Further, it is desirable that a leading end of the cleaning nozzle 124 has a true circular shape. When the leading end of the cleaning nozzle 124 has a true circular shape, it is possible to increase the amount of the cleaning liquid flowing into the paint reservoir.

The cleaning nozzle 124 may be arranged in plural along the circumference of the rotary atomizing head 125 so as to direct the outer paint discharge opening 142. As the cleaning nozzle 124 is arranged in plural, it is possible to increase the amount of the cleaning liquid flowing into the paint reservoir 144.

Next, a modification of the first exemplary embodiment will be described. The same reference numerals denote the same parts as in FIG. 2 and thus the detailed description thereof will be omitted.

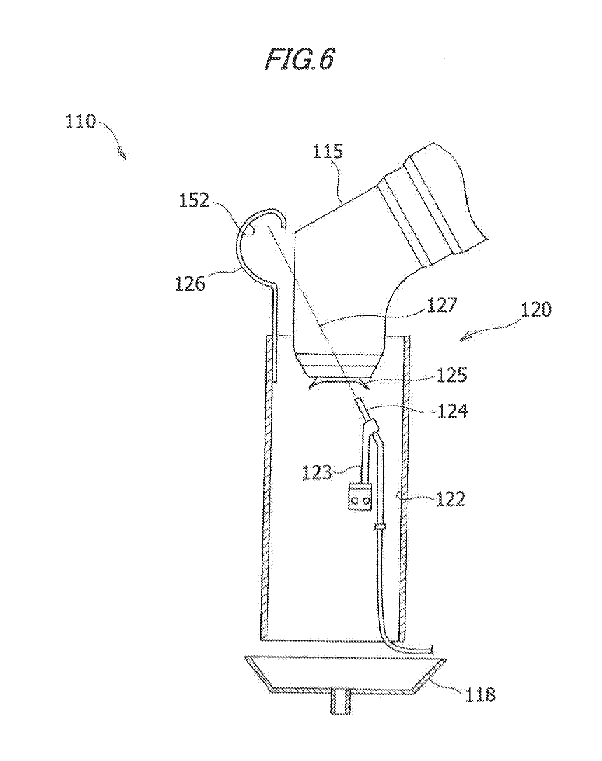

As illustrated in FIG. 6, the scattering prevention member is provided at its inner side with a curved portion 152. The cleaning liquid can drop inwards owing to the curved portion and therefore is prevented from being scattered.

### Second Exemplary Embodiment

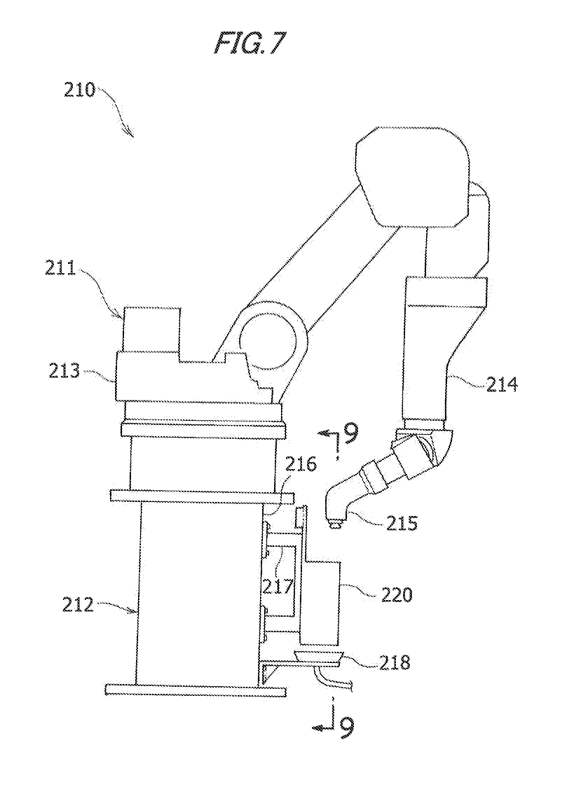

As illustrated in FIG. 7, in the second exemplary embodiment, coating equipment 210 includes a coating machine 211 and a cleaning apparatus 220 for a coating gun.

The coating machine 211 includes a fixation part 212, an industrial robot 213 provided on an upper portion of the fixation part 212 and a coating gun 215 provided on a leading end of an arm portion 214 of the industrial robot 213.

The cleaning apparatus 220 for for the coating gun is attached to a sidewall 216 of the fixation part 212 via a stay 217. Further, a cleaning liquid pan 218 receiving cleaning liquid after cleaning is arranged on a lower portion of the cleaning apparatus 220 for the coating gun.

Next, the cleaning apparatus 220 for the coating gun will be described on the basis of the cross-sectional view.

As illustrated in FIG. 8, the cleaning apparatus 220 for the coating gun includes a cylindrical container 221 through which a coating gun 215 can be inserted downwards from the top, a nozzle stay 223 (that is, stay for nozzle) provided on an inner peripheral surface 222 of the cylindrical container 221, a cleaning nozzle 225 attached to the nozzle stay 223 via a nozzle position adjusting mechanism 224 to inject the cleaning liquid and the cleaning liquid pan 218 provided on a lower portion of the cylindrical container 221 to receive the cleaning liquid after cleaning. As the cleaning liquid is injected from the cleaning nozzle 225, a rotary atomizing head 226 (as an object to be cleaned) rotatably provided on a leading end of the coating gun 215 can be cleaned.

Further, a scattering prevention member 227 is attached to the cylindrical container 221 to be placed on a central axis 228 of the cleaning nozzle 225. The scattering prevention member 227 allows the cleaning liquid to fall into the cylindrical container 221 when the cleaning liquid injected from the cleaning nozzle 225 does not strike the coating gun 215. Thereby, it is possible to prevent the cleaning liquid from being scattered to the outside.

Next, a cleaning nozzle for an external surface will be described.

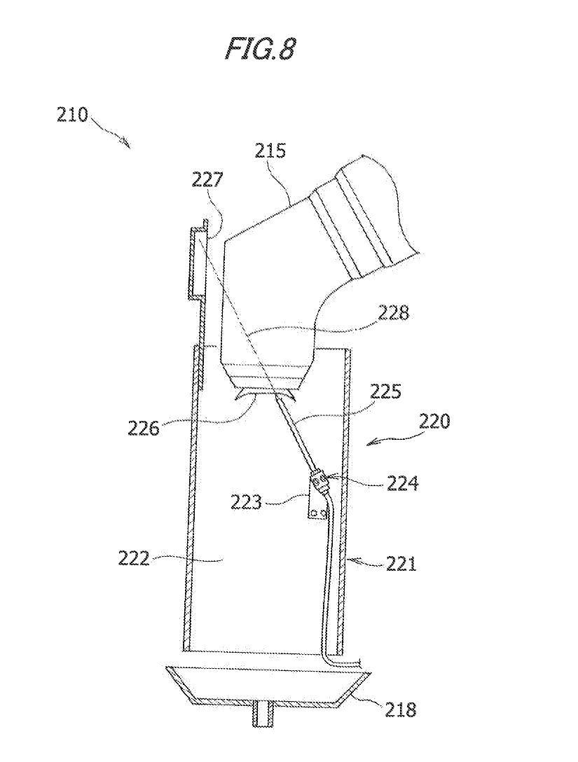

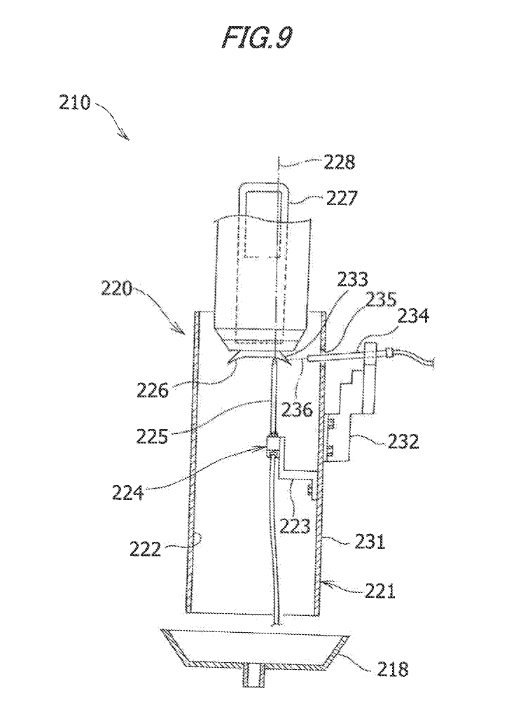

As illustrated in FIG. 9, the cleaning apparatus 220 for the coating gun includes an external surface cleaning nozzle 234 which is attached to an outer peripheral surface 231 of the cylindrical container 221 via an external surface nozzle stay 232. The external surface cleaning nozzle 234 is configured to inject the cleaning liquid on an external surface 233 of the rotary atomizing head 226. The external surface cleaning nozzle 234 extends through a through hole 235 of the cylindrical container 221 to the inside of the cylindrical container 221. The external surface cleaning nozzle 234 is positioned in such a way that the external surface 233 of the rotary atomizing head 226 is placed on an axis 236 of the external surface cleaning nozzle 234. Thereby, it is possible to clean the external surface 233 of the rotary atomizing head 226. The cleaning liquid after cleaning flows downwards along the inside of the cylindrical container 221 to be collected in the cleaning liquid pan 218.

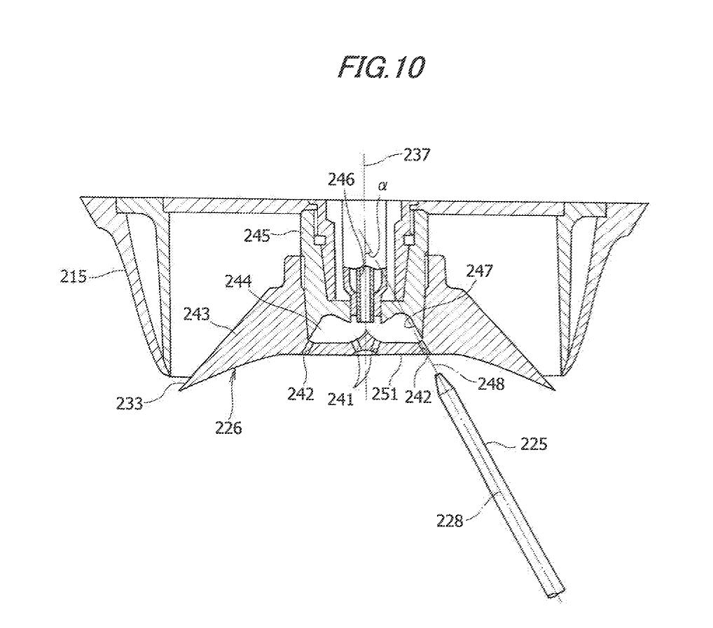

Next, the shape of the rotary atomizing head 226 will be described. As illustrated in FIG. 10, the rotary atomizing head 226 is rotatably provided on the leading and of the coating gun 215. The rotary atomizing head 226 is provided with central paint discharge openings 241 for discharging the paint in the vicinity of a rotation axis 237 of the rotary atomizing head 226 and outer paint discharge openings 242 for obliquely discharging the paint in a conical shape relative to the rotation axis 237.

The rotary atomizing head 226 includes an outer member 243, an inner member 245 and a paint feeding tube 246 for guiding the paint to the outer member 243. A paint reservoir 244 as a rear side of the rotary atomizing head 226 is formed between the outer member and the inner member.

The paint reservoir 244 is formed in a bell shape and a sidewall 247 thereof is smoothly connected to the outer paint discharge openings 242. Thereby, it is possible to smoothly discharge the paint.

The central axis 228 of the cleaning nozzle 225 is overlapped with the central axis 248 of the outer paint discharge openings 242. Man-hour is required for cleaning the sidewall 247 of the paint reservoir even when the cleaning liquid is supplied from the paint feeding tube. However, as the cleaning liquid is smoothly supplied from the cleaning nozzle 225 to the outer paint discharge openings 242, the sidewall 247 of the paint reservoir can be effectively cleaned.

The central axis 228 of the cleaning nozzle is offset relative to the rotation axis 237 by an angle of α. The cleaning liquid which is discharged from the cleaning nozzle 225 and does not flow into the outer paint discharge opening 242 is adapted to clean a bottom 251 of the rotary atomizing head 226.

Next, the nozzle position adjusting mechanism 224 for adjusting the position of the cleaning nozzle 225 will be described.

As illustrated in FIG. 11, the nozzle position adjusting mechanism 224 includes a support block 253 which is attached to the cleaning nozzle (reference numeral “220” in FIG. 7) via the cylindrical container 221 and the nozzle stay 223. The support block 253 is provided with a support hole 252 extending in an axial direction of the cleaning nozzle 225. A rotary block 256 is rotatably accommodated in the support hole 252. The rotary block 256 is formed with a nozzle insertion hole 255 which is provided at a position offset from a rotational center line 254 of the support hole 252. The cleaning nozzle 225 passes through the nozzle insertion hole. The central axis 228 of the cleaning nozzle is offset from the rotational center line 254 by a distance L1.

Further, a coupling mechanism 257 is installed in the support block 253 and the rotary block 256. The coupling mechanism 257 is configured to couple the rotary block 256 with the support block 253 in an arbitrary rotational orientation of the rotary block 256. The rotary block 256 is accommodated into and coupled to the support block 253 by the coupling mechanism 257 and fastened by a nut 258.

Next, the coupling mechanism 257 will be described.

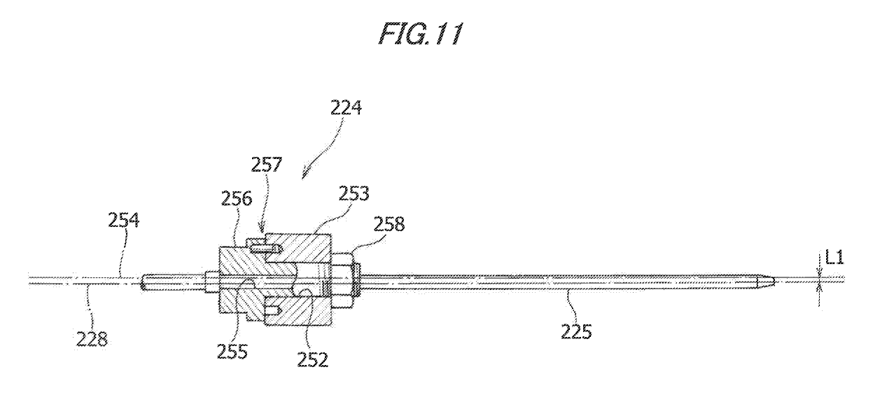

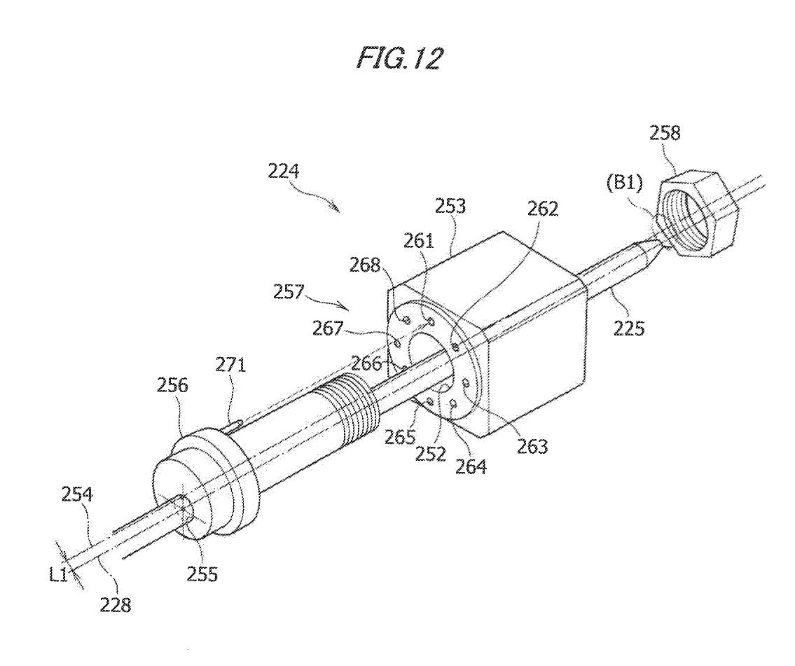

As illustrated in FIG. 12, the coupling mechanism 257 includes a plurality of pin holes 261 to 268 provided in the support block 253 to surround the support hole 252 and a pin 271 protruding from the rotary block 256 to be fitted into any one of the plurality of pin holes 261 to 268. As the pin 271 is decoupled from the pin hole 261 and coupled to the pin hole 262, the cleaning nozzle 225 can be displaced as indicated by arrow B1. Similarly, as the pin 271 is decoupled from the pin hole 262 and coupled to any one of the pin holes 263 to 268, the cleaning nozzle 225 can be displaced around the rotational center line 254. Here, a distance between the central axis 228 of the cleaning nozzle and the rotational center line 254 is represented as L1.

Hereinafter, an operation of the nozzle position adjusting mechanism 224 thus configured will be described.

As illustrated in FIG. 7, the pin 271 is fitted in the pin hole 261. As the rotary atomizing head 226 rotates, the outer paint discharge opening 242 moves on an orbit of an arrow B2. When the cleaning liquid is discharged on the rotary atomizing head 226 (as an object to be cleaned) through the cleaning nozzle 225, a position of the cleaning nozzle 225 is shifted relative to a position the outer paint discharge opening 242 of the rotary atomizing head 226 indicated by the arrow B2.

Accordingly, the coupling position of the pin 271 is changed into the pin hole 262, as indicated by arrow B3. The cleaning nozzle 225 is displaced to a position of the cleaning nozzle 225 illustrated in an imaginary line, as indicated by arrow B4. Similarly, the pin 271 is fitted into the pin hole 262 at a position where a shift amount thereof is the smallest. Specifically, when the rotary block (reference numeral “256” in FIG. 12) is rotated, the position of the cleaning nozzle 225 is adjusted in such a way that the cleaning nozzle is directed toward the outer paint discharge opening 242 of the rotary atomizing head 226 (as an object to be cleaned). As the cleaning nozzle is directed toward the outer paint discharge opening 242 of the rotary atomizing head 226 (as an object to be cleaned), the rotary block 256 is coupled to the support block 253 by the coupling mechanism 257. Consequently, the cleaning nozzle 225 is positioned on an orbit of the outer paint discharge opening 242 and therefore the cleaning liquid can effectively flow into the outer paint discharge opening 242.

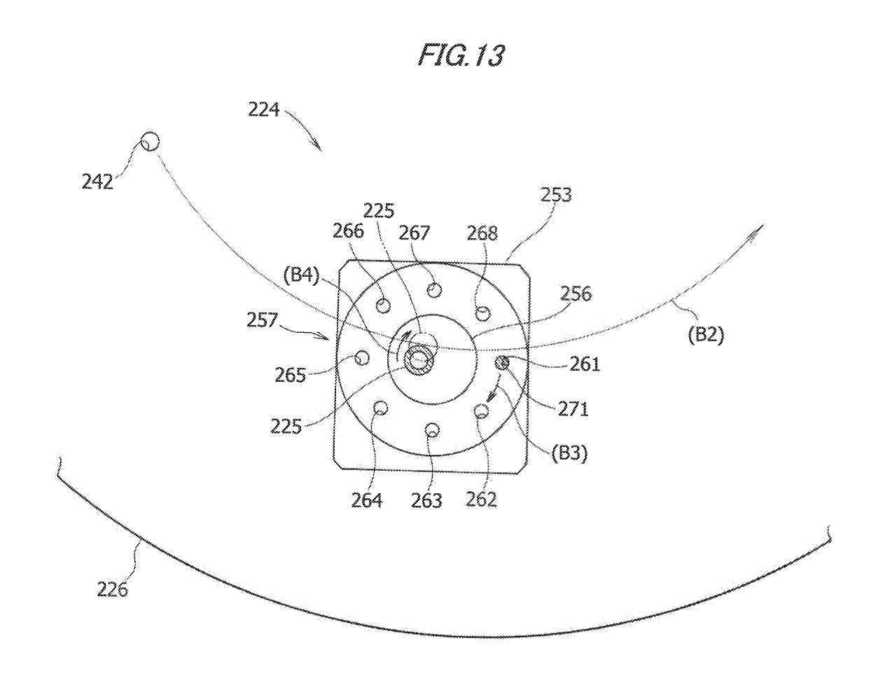

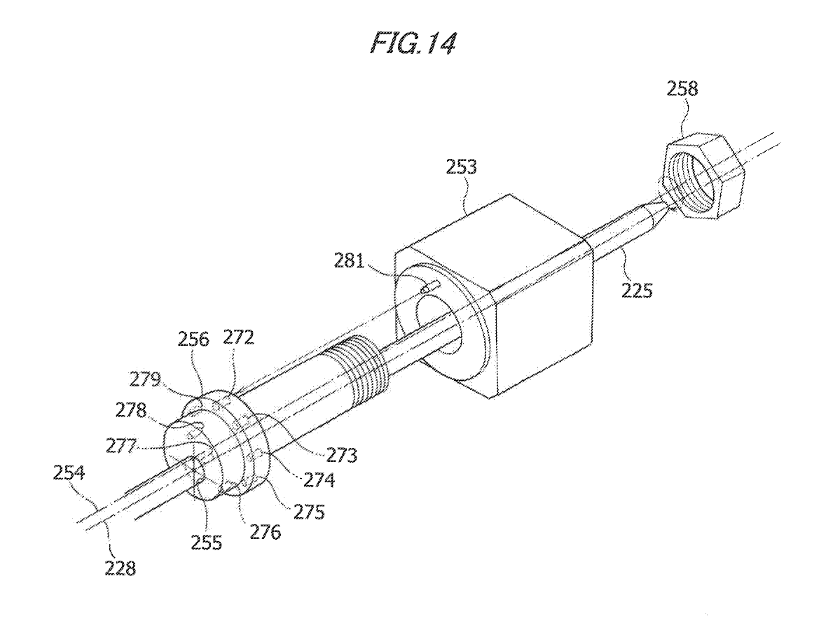

Next, a modification of the second exemplary embodiment will be described. The same reference numerals denote the same parts as in FIG. 12 and thus the detailed description thereof will be omitted. As illustrated in FIG. 14, the coupling mechanism may include a plurality of pin holes 272 to 279 provided in the rotary block 256 to surround the nozzle insertion hole 255 and a pin 281 protruding from the support block 253 to be fitted into any one of the plurality of pin holes 272 to 279.

### Third Exemplary Embodiment

As illustrated in FIG. 15, in the third exemplary embodiment, coating equipment 10 includes a coating machine 11 and a cleaning apparatus 20 for a rotary atomizing head.

The coating machine 11 includes a base part 12, an industrial robot 13 provided on an upper portion of the base part 12 and a coating gun 15 (as a main body of the coating machine) provided on a leading end of an arm portion 14 of the industrial robot 13.

The cleaning apparatus 20 for the rotary atomizing head is attached to a sidewall 16 of the base part 12 via a stay 17. Further, a cleaning liquid pan 18 receiving cleaning liquid after cleaning is arranged on a lower portion of the cleaning apparatus 20 for the rotary atomizing head.

Next, the cleaning apparatus 20 for the rotary atomizing head will be described.

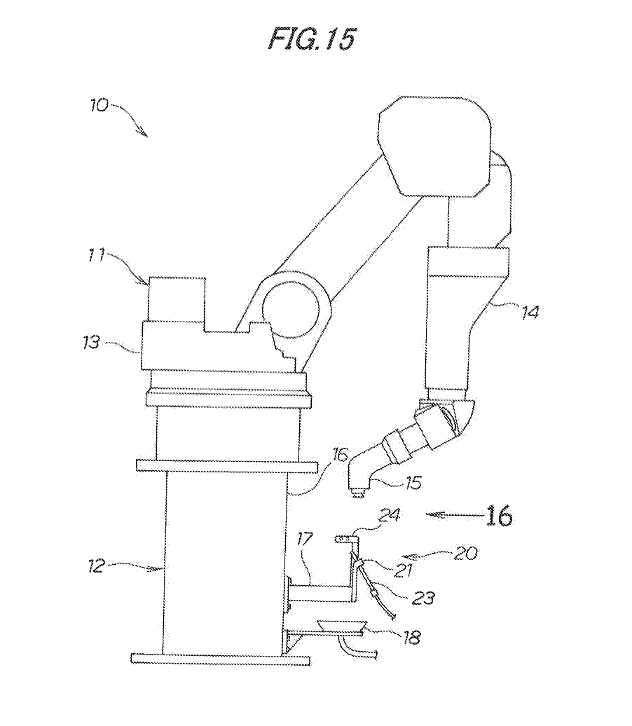

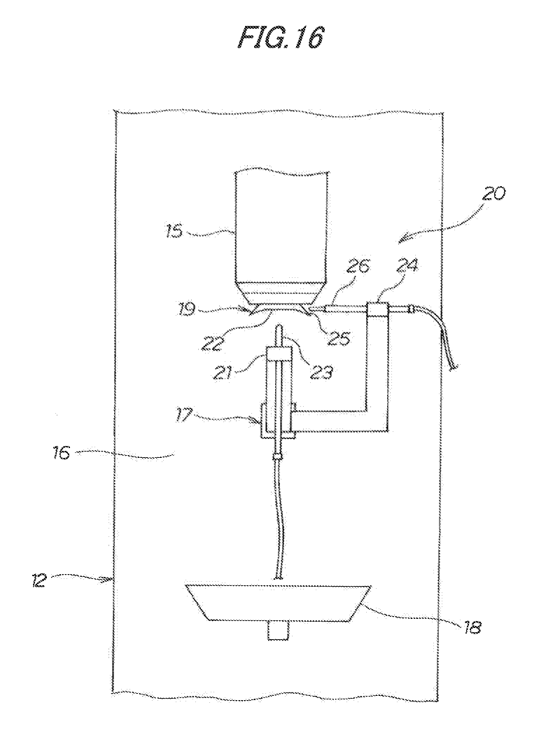

As illustrated in FIG. 16, a rotary atomizing head 19 is provided on a leading end of the coating gun 15.

The cleaning apparatus 20 for the rotary atomizing head includes a front surface liquid supply pipe 23 attached to a front surface supply pipe holding part 21 of the stay 17 and injecting the cleaning liquid on a front surface 22 of the rotary atomizing head 19, a rear surface liquid supply pipe 26 attached to a rear surface supply pipe holding part 24 of the stay 17 and supplying the cleaning liquid on a rear surface 25 of the rotary atomizing head 19 and the cleaning liquid pan 18 provided on a lower portion of the rear surface liquid supply pipe 26 and receiving the cleaning liquid after cleaning. As the cleaning liquid is injected from the front surface liquid supply pipe 23, the front surface 22 of the rotary atomizing head 19 rotatably provided on a leading end of the coating gun 15 can be cleaned.

Next, the shape of the rotary atomizing head 19 and the arrangement of the rear surface liquid supply pipe 26 will be described.

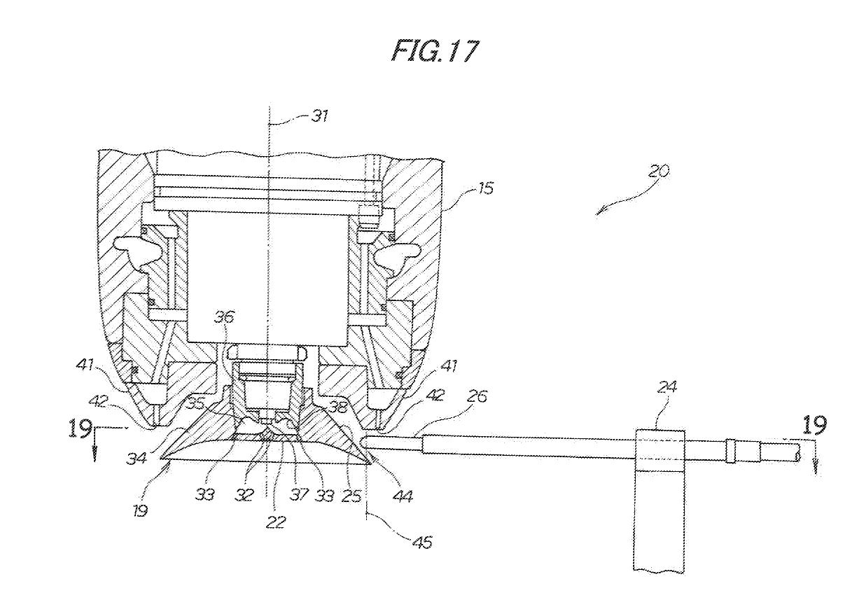

As illustrated in FIG. 17, the rotary atomizing head 19 is rotatably provided on the leading end of the coating gun 15. The rotary atomizing head 19 is provided with central paint discharge openings 32 for discharging the paint in the vicinity of a rotation axis 31 of the rotary atomizing head 19 and outer paint discharge openings 33 for obliquely discharging the paint in a conical shape relative to the rotation axis 31.

The rotary atomizing head 19 includes an outer member 34, an inner member 36 and a paint feeding tube 37. A paint reservoir 35 as a rear side of the rotary atomizing head 19 is formed between the outer member 34 and the inner member 36. The paint feeding tube 37 is configured to guide the paint to the paint reservoir 35.

The paint reservoir 35 is formed in a bell shape and an inner wall 38 thereof is smoothly connected to the outer paint discharge openings 33. Thereby, it is possible to smoothly discharge the paint.

The coating gun 15 is configured to inject the paint forward while atomizing the paint by supplying the paint to the front surface 22 of the conical rotary atomizing head 19 and then rotating the conical rotary atomizing head 19. Further, a shaping air ring 41 is provided on a leading end of the coating gun 15. The shaping air ring 41 is provided with an air hole 42 for blowing out the air.

Slit type air outlet may be provided, instead of the air hole 42.

The cleaning apparatus 20 for the rotary atomizing head is adapted to clean the rear surface 25 of the rotary atomizing head 19. The rear surface liquid supply pipe 26 of the cleaning apparatus 20 supplies the cleaning liquid and extends to the rear surface 25 of the rotary atomizing head 19. The rear surface liquid supply pipe 26 is provided with a discharge opening (will be described in detail later) for discharging the cleaning liquid on the rear surface 25 of the rotary atomizing head 19. The center line of the discharge opening is hanging on the rear surface 25.

Next, the position of the discharge opening will be described.

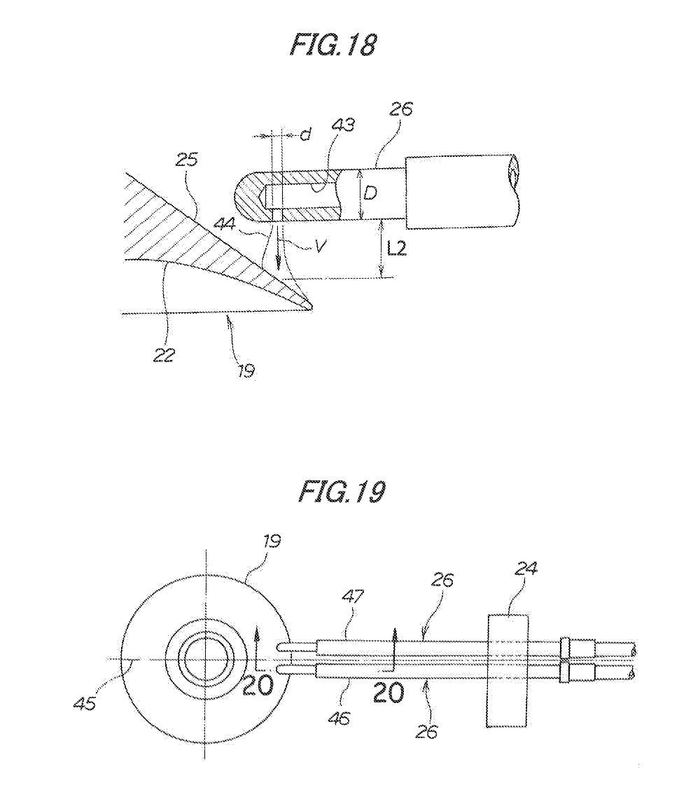

As illustrated in FIG. 18, the rear surface liquid supply pipe 26 is provided at its inside with a liquid passage 43 through which the cleaning liquid flows. The liquid passage 43 is connected to a discharge opening 44 for discharging the cleaning liquid. The rear surface 25 of the rotary atomizing head 19 can be cleaned by discharging the cleaning liquid through the discharge opening 44. The cleaning liquid after cleaning flows downward along the rear surface and is collected in the cleaning liquid pan (reference numeral 18 in FIG. 16).

Here, a distance from the discharge opening 44 to the rear surface 25 of the rotary atomizing head 19 is represented as L2 and a diameter of a leading end of the rear surface liquid supply pipe 26 is represented as D. It is desirable that the distance L2 is substantially equal to the diameter D.

When a diameter of the discharge opening 44 is represented as d and a flow velocity of the cleaning liquid discharged is represented as V. the flow rate Q is represented by a formula Q=π(d/2)²×V. Although the number of the discharge opening 44 is one in the present embodiment, the discharge opening 44 may be provided in plural.

Various combinations of the diameter d of the discharge opening 44, the number n of the discharge opening 44 and the flow rate Q with no rebound of cleaning liquid are represented in the following table 1.

TABLE 1

| | Diameter of | The number of | Flow rate |
|---|---|---|---|
| | discharge opening | discharge opening | with no rebound |
| Pattern | d (mm) | n (number) | Q |
| Pattern 1 | 1 | 1 | below 300 cm³/min |
| Pattern 2 | 0.7 | 2 | below 450 cm³/min |
| Pattern 3 | 0.7 | 3 | below 500 cm³/min |

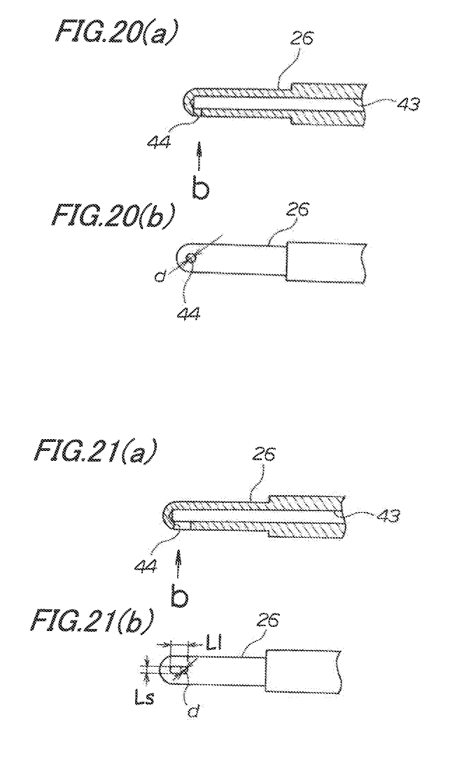

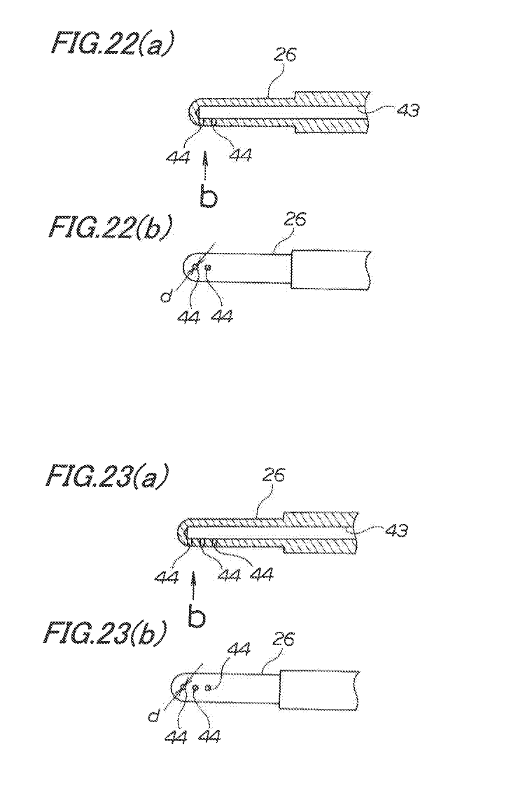

In the table 1, the pattern 1 is a form illustrated in FIG. 20 (a), FIG. 20 (b), FIG. 21 (a) and FIG. 21 (b), the pattern 2 is a form illustrated in FIG. 22 (a) and FIG. 22 (b) and the pattern 3 is a form illustrated in FIG. 23 (a) and FIG. 23 (b).

Further, the number of revolutions of the rotary atomizing head 19 is set below 30000 rpm.

Although the flow rate Q is set below 300 cm³/min in the pattern 1 of the table 1, it is more preferable that the flow rate Q is set below 200 cm³/min. Further, the flow rate may be suitably changed depending on the shape or size of the rotary atomizing head 19.

Next, an arrangement of a solvent supply pipe and a water supply pipe will be described.

As illustrated in FIG. 19, a solvent supply pipe 46 as a liquid supply pipe for sending solvent and a water supply pipe 47 as a liquid supply pipe for sending water are provided in the vicinity of a center line 45 of the rotary atomizing head 19 as seen from a plan view.

Next, the discharge opening 44 will be described.

As illustrated in FIG. 20 (a), the discharge opening 44 is opened at a leading end of the liquid passage 43 of the rear surface liquid supply pipe 26.

FIG. 20 (b) is a view as seen from arrow b of FIG. 20 (a). The discharge opening 44 is formed in a circular shape and provided in a single. The diameter d of the discharge opening 44 is equal to 1 mm.

Next, the discharge opening 44 of another form will be described.

As illustrated in FIG. 21 (a), the discharge opening 44 is opened at a leading end of the liquid passage 43 of the rear surface liquid supply pipe 26.

FIG. 21 (b) is a view as seen from arrow b of FIG. 21 (a). The discharge opening 44 is formed in a shape of an elongated hole and provided only in a single. The distance LI of the elongated hole in a longitudinal direction is equal to 1.4 mm and the width Ls thereof is equal to 0.6 mm.

Next, the discharge opening 44 of another form will be described.

As illustrated in FIG. 22 (a), two discharge opening 44 are opened at a leading end of the liquid passage 43 of the rear surface liquid supply pipe 26.

FIG. 22 (b) is a view as seen from arrow b of FIG. 22 (a). The discharge opening 44 is formed in a circular shape and provided in two. The diameter d of the discharge openings 44 is equal to 0.7 mm, respectively.

Next, the discharge opening 44 of yet another form will be described.

As illustrated in FIG. 23 (a), three discharge opening 44 are opened at a leading end of the liquid passage 43 of the rear surface liquid supply pipe 26.

FIG. 23 (b) is a view as seen from arrow b of FIG. 23 (a). The discharge opening 44 is formed in a circular shape and provided in three. The diameter d of the discharge openings 44 is equal to 0.7 mm, respectively.

The shape or number of the discharge opening 44 may be suitably changed, as long as a proper flow rate can be obtained.

Hereinafter, an operation of the coating gun 15 mentioned above will be described.

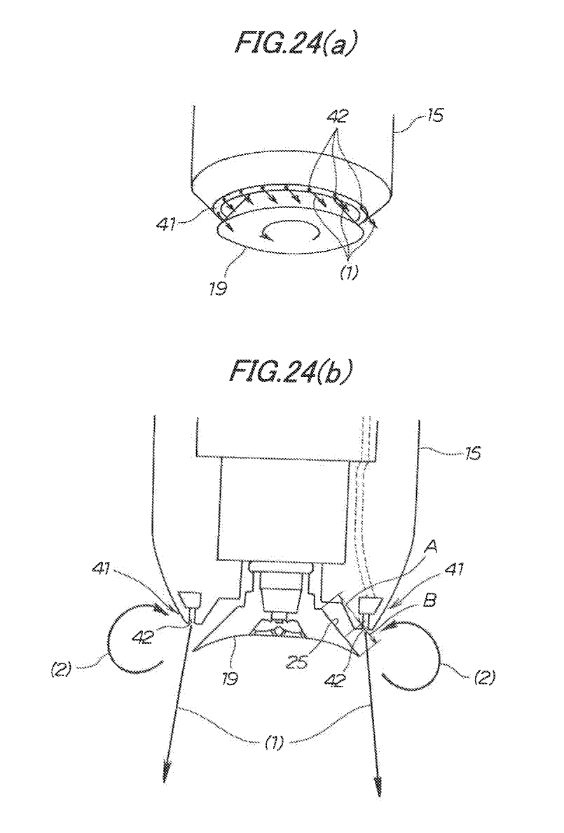

FIG. 24 (a) is a view for explaining the blow-off of air. The air is blown out from the air hole 42 provided on an end of the shaping air ring 41, as indicated by arrow (1). The paint supplied to the rotary atomizing head 19 is sprayed to be spread in an outer direction by a rotational centrifugal force of the rotary atomizing head 19. However, the spray direction of the air is limited by the air of the arrow (1).

FIG. 24 (b) is a view for explaining the flow of air and most of air flows as indicated by arrow (1). However, a portion of the air swirls as indicated by arrow (2). At this time, a portion of the paint sprayed is adhered to an area B of the rear surface 25 of the rotary atomizing head 19 by the air flow of arrow (2). But, an area A of the rear surface 25 is shaded by the shaping air ring 41 and thus the paint is not adhered to the area A.

Next, an operation of the cleaning apparatus 20 for cleaning the rear surface 25 of the rotary atomizing head 19 will be described.

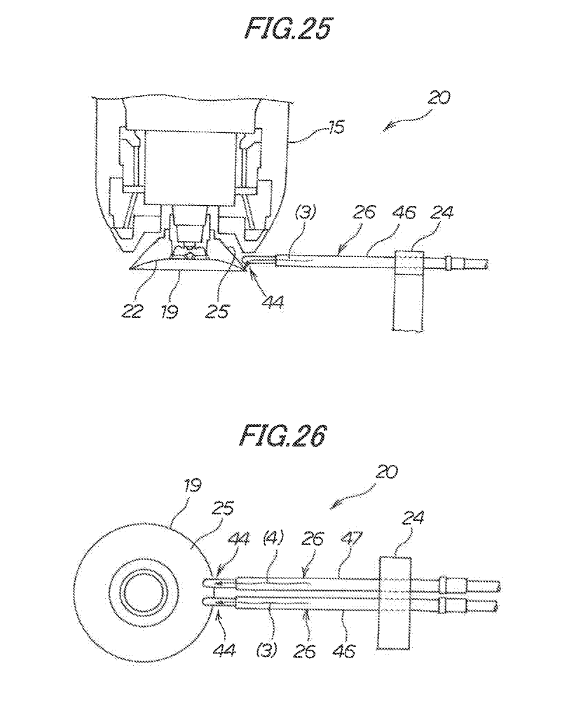

As illustrated in FIG. 25, the coating gun 15 is displaced to a position where the solvent supply pipe 46 reaches the rear surface 25 of the rotary atomizing head 19 (a liquid supply pipe placing process). Solvent as the cleaning liquid is supplied as indicated by arrow (3) and discharged on the rear surface 25 (a solvent discharging process).

Thinner is suitably used as the solvent. However, another cleaning liquid other than thinner may be used, as long as the rotary atomizing head 19 can be cleaned.

For example, the solvent may include an ester-based organic solvent such as ethyl acetate, butyl acetate, isobutyl acetate, 2-ethylhexyl acetate, cyclohexyl acetate, 3-methoxybutyl acetate, propylene glycol monomethyl ether acetate, or a ketone-based organic solvent such as acetone, methyl ethyl ketone, methyl isobutyl ketone, cyclohexanone, or an aliphatic hydrocarbon-based organic solvent such as n-butane, n-hexane, n-heptane, n-pentane, 2,2-dimethylpropane, 2-methylpentane, 3-methylpentane, 2,3-dimethylbutane, or an aromatic hydrocarbon-based organic solvent such as toluene, xylene, or an ether-based organic solvent such as ethylene glycol monomethyl ether, ethylene glycol monoethyl ether, ethylene glycol mono-n-propyl ether, ethylene glycol monoisopropyl ether, ethylene glycol mono-n-butyl ether, ethylene glycol mono-isobutyl ether, diethylene glycol monoisopropyl ether, diethylene glycol mono-n-butyl ether, diethylene glycol monoisobutyl ether, propylene glycol monomethyl ether, propylene glycol monoethyl ether, dipropylene glycol monomethyl ether, or an alcohol-based organic solvent such as methanol, isopropanol, isobutanol, n-butanol, 2-ethylhexanol, n-octanol, benzyl alcohol. These can be used alone or in combination of two or more.

Further, in some cases, water may be mixed into the solvent.

As illustrated in FIG. 26, following the discharge of the solvent, water as the cleaning liquid is supplied as indicated by arrow (4) and discharged on the rear surface 25 (a water discharging process).

### Fourth Exemplary Embodiment

Next, the fourth exemplary embodiment will be described by referring to the drawings. The same reference numerals denote the same parts as in FIG. 25 and thus the detailed description thereof will be omitted.

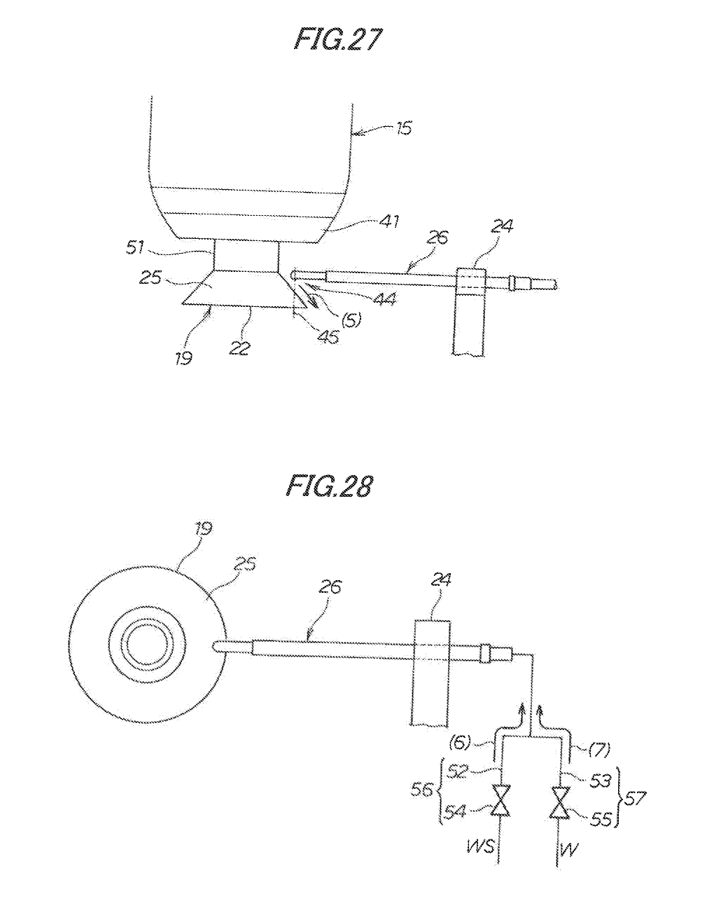

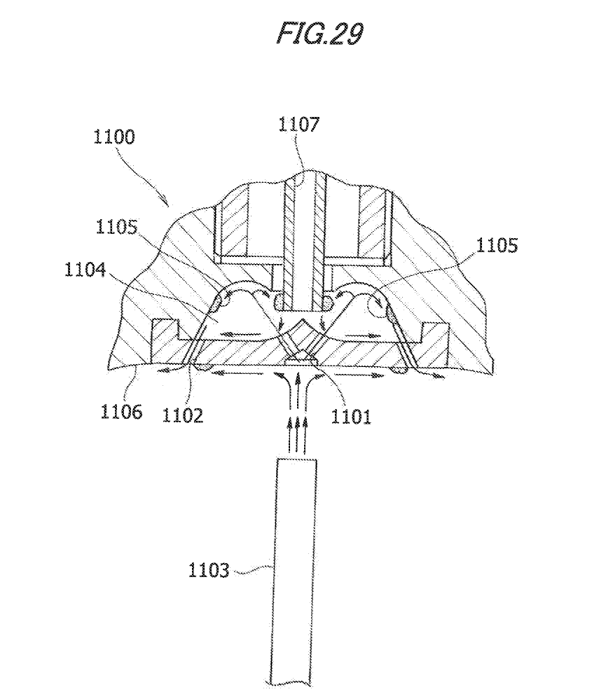

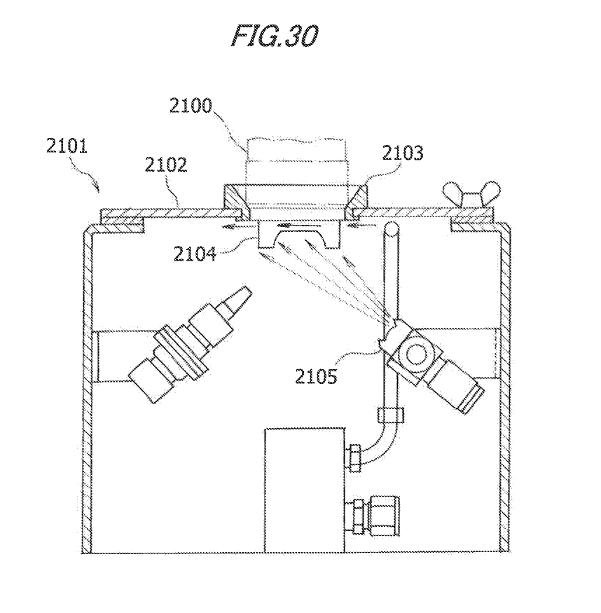

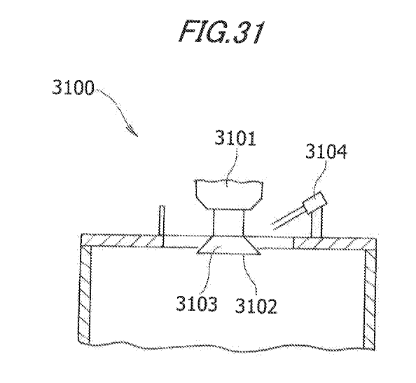

As illustrated in FIG. 27, the rotary atomizing head 19 is provided on a leading end of the coating gun 15. A neck part 51 is connected to an upper portion of the rear surface 25 of the rotary atomizing head 19. The rear surface 25 of the rotary atomizing head 19 is not shaded by the shaping air ring 41, but entirely exposed.

The rear surface liquid supply pipe 26 extends to the rear surface 25 of the rotary atomizing head 19.

Since the rear surface 25 is exposed, a portion of the paint sprayed is entirely adhered to the rear surface 25 during painting. When the paint thus adhered is cleaned, the coating gun 15 is displaced relative to the rear surface liquid supply pipe 26 so that the discharge opening 44 of the rear surface liquid supply pipe 26 can clean the rear surface 25 from an upper end to a lower end thereof while following arrow (5).

Other operations are same as the operation of the third exemplary embodiment.

### Fifth Exemplary Embodiment

Next, the fifth exemplary embodiment will be described by referring to the drawings. The same reference numerals denote the same parts as in FIG. 26 and thus the detailed description thereof will be omitted.

As illustrated in FIG. 28, a solvent passage 52 for supplying solvent and a water passage 53 for supplying water are connected to the rear surface liquid supply pipe 26. A solvent valve 54 for supplying solvent is provided in the solvent passage 52 and a water valve 55 for controlling the flow of water is provided in the water passage 53.

Next, an operation of the present embodiment will be described. The coating gun 15 is displaced to a position where the rear surface liquid supply pipe 26 reaches the rear surface 25 of the rotary atomizing head 19 (a liquid supply pipe placing process). Firstly, the solvent valve 54 is opened to supply solvent as indicated by arrow (6) and thus to clean the rear surface 25 of the rotary atomizing head 19 (a solvent discharging process). And then, the solvent valve 54 is closed. Subsequently, the water valve 55 is opened to supply water as indicated by arrow (7) and thus to clean the rear surface 25 (a water discharging process).

Further, a solvent feeding part 56 is composed of the solvent passage 52 and the solvent valve 54 and a water feeding part 57 is composed of the water passage 53 and the water valve 55.

For example, as illustrated in FIGS. 4 and 5 (b), according to the embodiments of the present invention, a cleaning method for the coating gun 115, 215 is provided. The rotary atomizing head 125, 226 is rotatably provided on a leading end of the coating gun 115, 215. The rotary atomizing head 125, 226 includes the central paint discharge opening 141, 241 provided in the vicinity of a rotation axis 137, 237 of the rotary atomizing head 125, 226 and the outer paint discharge opening 142, 242 having a central axis 148, 248 inclined relative to the rotation axis 137, 237. The cleaning method may include a process for placing the cleaning nozzle 124, 225 to oppose the outer paint discharge opening 142, 242 in such a way that an axis 127, 228 of the cleaning nozzle 124, 225 for injecting cleaning liquid is overlapped with a central axis 148, 248 of the outer paint discharge opening 142, 242 and a process for blowing the cleaning liquid from the cleaning nozzle 124, 225 into the outer paint discharge opening 142, 242 and discharging the cleaning liquid through the outer paint discharge opening 142, 242 or the central paint discharge opening 141, 241 to clean the rotary atomizing head 125, 226.

By this configuration, large amounts of cleaning liquid can be blown into the paint reservoir 144, 244 as a rear side of the rotary atomizing head 125, 226 through the outer paint discharge opening 142, 242. Accordingly, a cleaning man-hour can be shortened. Further, in a case where the number of the outer paint discharge openings 142, 242 is larger than that of the central paint discharge openings 141, 241, larger amounts of cleaning liquid can be blown into the paint reservoir 144, 244. Accordingly, a cleaning man-hour can be further shortened. In addition. as the cleaning liquid is blown into the paint reservoir through the outer paint discharge openings 142, 242, there is no case where the cleaning liquid flows backward to the paint feeding tube 146, 246 passing through the center of the rotary atomizing head 125, 226. As a result, there is no risk that the cleaning liquid flows backward to the paint feeding tube 146, 246 and thus cleaning efficiency of the rotary atomizing head 125, 226 can be improved.

Further, for example, as illustrated in FIGS. 1 to 4, according to multiple embodiments of the present invention, the cleaning apparatus 120, 220 for the coating gun 115, 215 is provided. The rotary atomizing head 125, 226 is rotatably provided on a leading end of the coating gun 115, 215. The rotary atomizing head 125, 226 includes the central paint discharge opening 141, 241 provided in the vicinity of a rotation axis 137, 237 of the rotary atomizing head 125, 226 and the outer paint discharge opening 142, 242 having a central axis 148, 248 inclined relative to the rotation axis 137, 237. The cleaning apparatus may include the cylindrical container 121, 221 through which the coating gun 115, 215 can be inserted downwards from the top and the cleaning nozzle 124, 225 attached to the cylindrical container 121, 221. The cleaning nozzle have an axis 127, 228 which is overlapped with a central axis 148, 248 of the outer paint discharge opening 142, 242 in a state where the coating gun 115, 215 is inserted into the cylindrical container 121, 221 and is configured to inject cleaning liquid in the outer paint discharge opening 142, 242.

By this configuration, large amounts of cleaning liquid can be blown into the paint reservoir 144, 244 as a rear side of the rotary atomizing head 125, 226 through the outer paint discharge opening 142, 242. Accordingly, a cleaning man-hour can be shortened. Further, in a case where the number of the outer paint discharge openings 142, 242 is larger than that of the central paint discharge openings 141, 241, larger amounts of cleaning liquid can be blown into the paint reservoir 144, 244. Accordingly, a cleaning man-hour can be further shortened. In addition, as the cleaning liquid is blown into the paint reservoir through the outer paint discharge openings 142, 242, there is no case where the cleaning liquid flows backward to the paint feeding tube 146, 246 passing through the center of the rotary atomizing head 125, 226. In addition, since there is the cylindrical container 121, 221, it is possible to prevent the cleaning liquid from being scattered around.

Further, as illustrated in FIGS. 2 and 6, the cleaning apparatus 120, 220 may include the scattering prevention member 126, 227 provided on the cylindrical container 121, 221 and arranged on an extension line of an axis 127, 228 of the cleaning nozzle 124, 225. The scattering prevention member 126, 227 allows the cleaning liquid to fall into the cylindrical container 121, 221 when the cleaning liquid injected from the cleaning nozzle 124, 225 does not strike the coating gun 115, 215.

By this configuration, it is possible to prevent the cleaning liquid from being scattered, even when the cleaning liquid is discharged due to an erroneous operation, etc.

Further, for example, as illustrated in FIGS. 4 and 5 (b), a leading end of the cleaning nozzle 124, 225 may have a true circular shape.

By this configuration, since the straightness of the cleaning liquid is improved, the amounts of the cleaning liquid blown into the paint reservoir 144, 244 as a rear side of the rotary atomizing head 125, 226 increase. Accordingly, it is possible to improve the cleaning efficiency.

Further, for example, as illustrated in FIG, 5 (b), the cleaning nozzle 124, 225 may be arranged in plural and the plural cleaning nozzles 124, 225 may be arranged along the circumference of the rotary atomizing head 125, 226 in a state where the coating gun 115, 215 is inserted into the cylindrical container 121, 221.

By this configuration, since the cleaning liquid can be blown into the paint reservoir through the plural outer paint discharge openings 142, 242, it is possible to improve the cleaning efficiency. In addition, since the cleaning liquid can be blown into the paint reservoir 144, 244 as a rear side of the rotary atomizing head 125, 226 without rotating the rotary atomizing head 125, 226, large amounts of cleaning liquid can be blown into the paint reservoir. Accordingly, it is possible to further improve the cleaning efficiency.

Further, for example, as illustrated in FIG. 12, according to the embodiments of the present invention, the cleaning apparatus 220 may include a support block 253, a rotary block 256 rotatably supported on the support block 253 and a cleaning nozzle 225 inserted into a nozzle insertion hole 255 which is provided on the rotary block 256. A rotational center line 254 of the rotation of the rotary block 256 relative to the support block 253 and a central axis 228 of the cleaning nozzle 225 may be parallel to and offset from each other.

By this configuration, since the position of the cleaning nozzle 225 is adjusted just by rotating the rotary block 256 to be fixed to the support block 253, it is possible to easily align the central axis 228 of the cleaning nozzle 225 with the outer paint discharge opening 242 of the rotary atomizing head 226 (as an object to be cleaned).

Further, for example, as illustrated in FIG. 12, the cleaning apparatus 220 may further include a coupling mechanism 257 for fixing the rotary block 256 to the support block 253 at an arbitrary rotational position of the rotary block 256 relative to the support block 253. The support block 253 may be provided with a support hole 252 extending in a direction parallel to the central axis 228 of the cleaning nozzle 225. The rotary block 256 may be accommodated in the support hole 252. The coupling mechanism 257 may include a plurality of pin holes 261 to 268 provided in the support block 253 to surround the support hole 252 and a pin 271 protruding from the rotary block 256 to be fitted into any one of the plurality of pin holes 261 to 268.

By this configuration, since the part design is simple, it is possible to reduce the part cost.

Further, for example, as illustrated in FIG. 14, the cleaning apparatus 220 may further include a coupling mechanism 257 for fixing the rotary block 256 to the support block 253 at an arbitrary rotational position of the rotary block 256 relative to the support block 253. The support block 253 may be provided with a support hole 252 extending in a direction parallel to the central axis 228 of the cleaning nozzle 225. The rotary block 256 may be accommodated in the support hole 252. The coupling mechanism 257 may include a plurality of pin holes 272 to 279 provided in the rotary block 256 to surround the nozzle insertion hole 255 and a pin 281 protruding from the support block 253 to be fitted into any one of the plurality of pin holes 272 to 279.

By this configuration, since the pin holes 272 to 279 can be easily processed in the rotary block 256, it is possible to reduce the processing cost of the parts.

Further, for example, as illustrated in FIG. 13, a nozzle position adjusting method in a cleaning apparatus is provided. An object 226 to be cleaned is provided to be movable toward the cleaning apparatus 220, the cleaning apparatus 220 is provided with the cleaning nozzle 225 for discharging cleaning liquid on the object 226 to be cleaned, and the cleaning apparatus 220 is provided with a nozzle position adjusting mechanism 224 for adjusting a positional shift when a position of the cleaning liquid discharged from the cleaning nozzle 225 is shifted from a position of the objected 226 to be cleaned. The nozzle position adjusting method may include a process for preparing a support block 253 which is provided on the cleaning apparatus 220 and has a support hole 252 extending in a direction parallel to a central axis 228 of a cleaning nozzle 225, a rotary block 256 which is rotatably accommodated in the support hole 252 and has a nozzle insertion hole 255 provided at a position offset from a rotational center line 254 of the support hole, and a coupling mechanism 257 which is configured to fix the rotary block 256 to the support block 253 at an arbitrary rotational position of the rotary block 256, the cleaning nozzle 225 passing through the nozzle insertion hole 255; a process for moving an object 226 to be cleaned and stopping the object 226 to be cleaned when a distance between the object to be cleaned and the cleaning nozzle 225 is the smallest; a process for rotating the rotary block 256 to adjust an oriented direction of the cleaning nozzle 225 and, a process for coupling the rotary block 256 to the support block 253 by the coupling mechanism 257.

By this configuration, the process for adjusting the position of the cleaning nozzle 225 can be carried out just by rotating the rotary block 256. Accordingly, the rotational operation is easy and therefore the position of the cleaning nozzle 225 can be easily adjusted.

Further, since the adjusting process can be carried out just by rotating the rotary block 256 in the present embodiment, the time required for the adjusting process becomes short, as compared to a process for teaching a painting robot.

For example, as illustrated in FIG. 17, according to the embodiments of the present invention, a cleaning apparatus 20 for a rotary atomizing head is provided. The cleaning apparatus is utilized to clean the rear surface 25 of the rotary atomizing head 19 of the coating gun 15 and the coating gun 15 is configured to inject the paint forward while atomizing the paint by rotating the rotary atomizing head 19. The cleaning apparatus may include a liquid supply pipe 26 extending to the rear surface 25 of the rotary atomizing head 19 and supplying cleaning liquid and a discharge opening 44 opened to the liquid supply pipe 26 and discharging the cleaning liquid on the rear surface 25 of the rotary atomizing head 19.

By this configuration, since the discharge opening 44 for discharging the cleaning liquid is provided in the vicinity of the rear surface 25 of the rotary atomizing head 19, it is possible to discharge the cleaning liquid without being scattered. Accordingly, there is no risk that the cleaning liquid is scattered to the coating apparatus main body 15 during cleaning of the rear surface 25 of the rotary atomizing head 19.

Further, for example, as illustrated in FIG. 19, the liquid supply pipe 26 may include a solvent supply pipe 46 for sending solvent and a water supply pipe 47 for sending water.

When the rotary atomizing head 19 is made of aluminum, there is a possibility that the rotary atomizing head can be corroded upon cleaning using solvent alone. However, by the above configuration, the corrosion of the rotary atomizing head can be prevented by washing out the solvent on the rotary atomizing head 19 with water supplied from the water supply pipe 47.

Further, for example, as illustrated in FIG. 28, a solvent feeding part 56 for sending the solvent and a water feeding part 57 for sending the water may be connected to the liquid supply pipe 26 and either one of the solvent or the water may be sent to the liquid supply pipe 26.

By this configuration, since the liquid supply pipe 26 is commonly used to both solvent supplying and water supplying, it is possible to reduce the number of the liquid supply pipe 26.

Further, for example, as illustrated in FIG. 25, a cleaning method for a rotary atomizing head is provided. The cleaning apparatus is utilized to clean the rear surface 25 of the rotary atomizing head 19 of the coating gun 15 and the coating gun 15 is configured to inject the paint forward while atomizing the paint by rotating the rotary atomizing head 19. The cleaning method may include a process for placing a liquid supply pipe 26 for sending cleaning liquid to be extended to a rear surface 25 of the rotary atomizing head 19 and a process for discharging solvent on the rear surface 25 through a discharge opening 44 opened to the liquid supply pipe 26.

By this configuration, since the cleaning liquid is discharged from the vicinity of the rotary atomizing head 19, the cleaning liquid can be discharged so as not to be scattered. Accordingly, it is possible to clean the rear surface 25 of the rotary atomizing head 19 while preventing the cleaning liquid from being scattered to the coating apparatus main body 15.

Further, since most of the cleaning liquid discharged from the vicinity of the rotary atomizing head 19 is adapted to strike the rear surface 25 of the rotary atomizing head 19, it is possible to reduce the amounts of cleaning liquid wastefully discharged and therefore the cleaning efficiency can be improved.

Further, for example, as illustrated in FIG. 26, the cleaning method for the rotary atomizing head may include a process for discharging water on the rear surface 25 through the discharge opening 44 opened to the liquid supply pipe 26, following the solvent discharging process.

When the rotary atomizing head 19 is made of aluminum, there is a possibility that the rotary atomizing head can be corroded upon cleaning using solvent alone. However, by the above configuration, the corrosion of the rotary atomizing head can be prevented by washing out the solvent on the rotary atomizing head 19 with water supplied from the water supply pipe 47. Consequently, it is possible to prolong the life of the rotary atomizing head 19.

In the respective exemplary embodiments mentioned above, the cleaning technique of the present invention has been applied to a coating gun mounted on an industrial robot. However, the present invention is not limited to such an application. The present invention may be applied to another coating gum, as long as the rotary atomizing head of the coating gun can be cleaned.

### INDUSTRIAL APPLICABILITY

### Description of Reference Numerals

15 Coating gun (Coating apparatus main body)
19 Rotary atomizing head
20 Cleaning apparatus for rotary atomizing head
22 Front face of rotary atomizing head
25 Rear face of rotary atomizing head
26 Liquid supply pipe
44 Discharge opening
46 Liquid supply pipe (Solvent supply pipe)
47 Liquid supply pipe (Water supply pipe)
56 Solvent feeding part
57 Water feeding part
115 Coating gun
118 Cleaning liquid pan
120 Cleaning apparatus for coating gun
121 Cylindrical container
122 Inner peripheral surface
124 Cleaning nozzle
125 Rotary atomizing head
126 Scattering prevention member
127 Axis of cleaning nozzle
137 Rotating axis of rotary atomizing head
141 Central paint discharge opening
142 Outer paint discharge opening
148 Central axis of outer paint discharge opening
210 Coating equipment
215 Coating gun
220 Cleaning apparatus
224 Nozzle position adjusting mechanism
225 Cleaning nozzle
226 Object to be cleaned (rotary atomizing head)
242 Outer paint discharge opening
252 Support hole
253 Support block
254 Rotational center line
255 Nozzle insertion hole
256 Rotary block
257 Coupling mechanism
261 to 268 Pin hole
271 Pin
272 to 279 Pin hole
281 Pin

1. A cleaning apparatus (120, 220) for a coating gun (115, 215), wherein the coating gun (115, 215) includes a rotary atomizing head (125, 226) which is rotatably provided on a leading end of the coating gun (115, 215), and wherein the rotary atomizing head (125, 226) includes a central paint discharge opening (141, 241) provided in a vicinity of a rotation axis (137, 237) of the rotary atomizing head (125, 226) and an outer paint discharge opening (142, 242) having a central axis (148, 248) inclined relative to the rotation axis (137, 237), the apparatus comprising:
a cylindrical container (121, 221) to which the coating gun (115, 215) can be inserted downwards from a top of the cylindrical container (121, 221); and
a cleaning nozzle (124, 225) attached to the cylindrical container (121, 221), having an axis (127, 228) which aligns with the central axis (148, 248) of the outer paint discharge opening (142, 242) in a state where the coating gun (115, 215) is inserted into the cylindrical container (121, 221), and configured to inject cleaning liquid to the outer paint discharge opening (142, 242).

2. The cleaning apparatus according to claim 1, further comprising:
a scattering prevention member (126, 227) provided on the cylindrical container (121, 221) and arranged on an extension line of the axis (127, 228) of the cleaning nozzle (124, 225), wherein the scattering prevention member (126, 227) makes the cleaning liquid fall into the cylindrical container (121, 221) when the cleaning liquid injected from the cleaning nozzle (124, 225) does not strike the coating gun (115, 215).

3. The cleaning apparatus according to claim 1, wherein a leading end of the cleaning nozzle (124, 225) has a true circular shape.

4. The cleaning apparatus according to claim 1, wherein a plurality of the cleaning nozzles (124, 225) are provided, and the cleaning nozzles (124, 225) are arranged along a circumference of the rotary atomizing head (125, 226) in a state where the coating gun (115, 215) is inserted into the cylindrical container (121, 221).

5. A cleaning apparatus comprising:
a support block (253);
a rotary block (256) rotatably supported on the support block (253); and
a cleaning nozzle (225) inserted into a nozzle insertion hole (255) provided on the rotary block (256),
wherein a rotational center line (254) of a rotation of the rotary block (256) relative to the support block (253) and a central axis (228) of the cleaning nozzle (225) are parallel to each other and offset from each other.

6. The cleaning apparatus according to claim 5, further comprising:
a coupling mechanism (257) adapted to fix the rotary block (256) to the support block (253) at an arbitrary rotational position of the rotary block (256) relative to the support block (253),
wherein the support block (253) is provided with a support hole (252) extending in a direction parallel to the central axis (228) of the cleaning nozzle (225),
wherein the rotary block (256) is accommodated in the support hole (252), and
wherein the coupling mechanism (257) includes a plurality of pin holes (261 to 268) provided in the support block (253) to surround the support hole (252) and a pin (271) protruding from the rotary block (256) to be fitted into any one of the plurality of pin holes (261 to 268).

7. The cleaning apparatus according to claim 5, further comprising:
a coupling mechanism (257) adapted to fix the rotary block (256) to the support block (253) at an arbitrary rotational position of the rotary block (256) relative to the support block (253),
wherein the support block (253) is provided with a support hole (252) extending in a direction parallel to the central axis (228) of the cleaning nozzle (225),
wherein the rotary block (256) is accommodated in the support hole (252), and
wherein the coupling mechanism (257) includes a plurality of pin holes (272 to 279) provided in the rotary block (256) to surround the nozzle insertion hole (255) and a pin (281) protruding from the support block (253) to be fitted into any one of the plurality of pin holes (272 to 279).

8. A cleaning method for a coating gun (115, 215), wherein the coating gun (115, 215) includes a rotary atomizing head (125, 226) which is rotatably provided on a leading end of the coating gun (115, 215), and wherein the rotary atomizing head (125, 226) includes a central paint discharge opening (141, 241) provided in a vicinity of a rotation axis (137, 237) of the rotary atomizing head (125, 226) and an outer paint discharge opening (142, 242) having a central axis (148, 248) inclined relative to the rotation axis (137, 237), the method comprising:
placing a cleaning nozzle (124, 225) to oppose the outer paint discharge opening (142, 242) such that an axis (127, 228) of the cleaning nozzle (124, 225) adapted to inject cleaning liquid align with the central axis (148, 248) of the outer paint discharge opening (142, 242); and
injecting the cleaning liquid from the cleaning nozzle (124, 225) to the outer paint discharge opening (142, 242) and discharging the cleaning liquid from the central paint discharge opening (141, 241) or the outer paint discharge opening (142, 242) to clean the rotary atomizing head (125, 226).

9. A nozzle position adjusting method in a cleaning apparatus, wherein an object (226) to be cleaned is provided to be movable toward the cleaning apparatus (220), the cleaning apparatus (220) includes a cleaning nozzle (225) adapted to discharge cleaning liquid to the object (226), and the cleaning apparatus (220) includes a nozzle position adjusting mechanism (224) adapted to adjust a positional shift when a position of the cleaning liquid discharged from the cleaning nozzle (225) is shifted from a position of the objected (226), the method comprising:
preparing a support block (253) that is provided on the cleaning apparatus (220) and has a support hole (252) extending in a direction parallel to a central axis (228) of the cleaning nozzle (225), a rotary block (256) that is rotatably accommodated in the support hole (252) and has a nozzle insertion hole (255) which is provided at a position offset from a rotational center line (254) of the support hole and through which the cleaning nozzle passes, and a coupling mechanism (257) adapted to fix the rotary block (256) to the support block (253) at an arbitrary rotational position of the rotary block (256);
moving the object (226) and stopping the object (226) when a distance between the object and the cleaning nozzle (225) is the smallest;
rotating the rotary block (256) to adjust an oriented direction of the cleaning nozzle (225); and,
coupling the rotary block (256) to the support block 253 by the coupling mechanism (257).

10. A cleaning apparatus (20) for a rotary atomizing head, in which a rear surface (25) of the rotary atomizing head (19) of a coating gun (15) adapted to inject paint forward while atomizing the paint by rotating the rotary atomizing head (19) is cleaned, the apparatus comprising:
a liquid supply pipe (26) extending to the rear surface (25) of the rotary atomizing head (19) and to which cleaning liquid is supplied; and
a discharge opening (44) opened to the liquid supply pipe (26) and adapted to discharge the cleaning liquid to the rear surface (25) of the rotary atomizing head (19).

11. The cleaning apparatus for the rotary atomizing head according to claim 10, wherein the liquid supply pipe (26) includes a solvent supply pipe (46) adapted to feed solvent and a water supply pipe (47) adapted to feed water.

12. The cleaning apparatus for the rotary atomizing head according to claim 10, wherein a solvent feeding part (56) adapted to feed solvent and a water feeding part (57) adapted to feed water are connected to the liquid supply pipe (26), and either one of the solvent or the water is sent to the liquid supply pipe (26).

13. A cleaning method for a rotary atomizing head, in which a rear surface (25) of the rotary atomizing head (19) of a coating gun (15) adapted to inject paint forward while atomizing the paint by rotating the rotary atomizing head (19) is cleaned, the method comprising:
extending a liquid supply pipe (26) that feeds cleaning liquid to a rear surface (25) of the rotary atomizing head (19); and
discharging solvent to the rear surface (25) from a discharge opening (44) which is opened to the liquid supply pipe (26).

14. The cleaning method for the rotary atomizing head according to claim 13, the method further comprising:
discharging water to the rear surface from the discharge opening which is opened to the liquid supply pipe, after discharging the solvent.

15. The cleaning apparatus according to claim 2, wherein a plurality of the cleaning nozzles (124, 225) are provided, and the cleaning nozzles (124, 225) are arranged along a circumference of the rotary atomizing head (125, 226) in a state where the coating gun (115, 215) is inserted into the cylindrical container (121, 221).

16. The cleaning apparatus according to claim 3, wherein a plurality of the cleaning nozzles (124, 225) are provided, and the cleaning nozzles (124, 225) are arranged along a circumference of the rotary atomizing head (125, 226) in a state where the coating gun (115, 215) is inserted into the cylindrical container (121, 221).
